(19) United States
(12) Patent Application Publication
(10) Pub. No.: US 2015/0071027 A1
(43) Pub. Date: Mar. 12, 2015

(54) PORTABLE STIRRING DEVICE

(71) Applicant: DIMITRI CADOS, Orinda, CA (US)

(72) Inventor: DIMITRI CADOS, Orinda, CA (US)

(21) Appl. No.: 14/020,648

(22) Filed: Sep. 6, 2013

(51) Int. Cl. B01F 7/00

(52) U.S. Cl. CPC B01F 7/00725
USPC 366/331

(57) ABSTRACT

A stirring apparatus for agitating fluids in a container utilizing a motor powered by a source of power. The motor includes an output shaft that is connected to a bar. The bar supports, at its terminus, first and second arms that extend outwardly. Flanges are positioned on each of the arms and act hydrodynamically to adjust the length of such arms according to the diameter of a particular container. One arm is stopped to form an angular orientation between such arm and the bar connected to the output shaft of the motor.

### CROSS-REFERENCES TO RELATED APPLICATIONS

The present application claims the benefit of U.S. Provisional Patent Application Ser. No: 61/832,638, filed 7 Jun. 2013.

### BACKGROUND OF THE INVENTION

The present invention relates to a novel and useful stirring apparatus for mixing or agitating fluids in a container.

Fluids and mixtures, such as foodstuffs, are often placed in a container and need to be mixed or stirred in order to complete a particular preparation processes. Due to variations in viscosity of a particular fluid mixture, it is important that all levels of the mixture within a container be stirred or agitated.

In the case of a foodstuff, a failure to stir the ingredients in a container while cooking may result in an unevenly cooked product or scorching of the contents at the bottom of the container.

Currently there are certain commercial stirring devices that are used to stir the contents of the container. For example the Robo Stir device is placed on the bottom of the container and contains three plastic rotating legs to stir the contents. However, the Robo Stir device has limited use due to low power capacity and fragile construction. Another commercial device, known as the Ardente Stirrer attaches to the top of a pot or container that includes paddles that extend downwardly into the container for rotation. However, the Ardente Stirrer is limited to particular containers having handles.

In addition, many other stirring and agitating devices have been proposed in the past. For example, United States Design Patent Des421,616 shows a mixing device that clamps to the top of the container and includes a shaft chuck which allows a mixing terminus to extend into the container.

U.S. Pat. No. 3,960,369 describes a stirring mechanism in which a battery operated roller is mounted to move about the top rim of a container to allow a motor and mixing arms to extend into the container to sweep the contents of the container.

U.S. Pat. No. 5,476,321 shows a container stirring device that sits on a surface adjacent the container and includes a stirring implement in the form of a perforated paddle to move within the container.

U.S. Pat. Nos. 4,832,501, 5,613,425, and 6,113,258 describe container fluid mixers that straddle the top portion of the container and permit the extension of stirrers downwardly therefrom.

U.S. Pat. No. 2,578,901 and 2,707,622 illustrate stirring mixer that affix to the side of a container and permit the use of beaters to be immersed within the contents of the container.

U.S. Pat. Nos. 2,140,315, 2,209,287, 2,805,843, 2,828,114, 3,068,186, 3,905,585, 5,332,310, and 6,749,331 teach mixing devices that clip on or clamp on to the side of a container and allow the extension of mixing arms into the contents of the container.

U.S. Pat. Nos. 1,167,536, and 6,286,990, show agitating and mixing devices that include stirring ends that pivot relative to a central shaft and include flanges that extend upwardly along the side of the container.

U.S. Pat. Nos. 4,576,089, 5,617,774, describes stirring apparatuses that include arms extending from a central shaft that pivot and may be moved upwardly towards the central shaft when not in use.

U.S. Pat. Nos. 5,533,805 and 5,653,536 utilize stirrers that are free-standing or wall mounted and include adjustable arms and terminal stirring mechanisms.

A mixing apparatus that is capable of self-adjusting its position to mix the contents of different sized containers, and includes stirring portions that automatically position according to the level of the liquid within the container would be a notable advance in the field of food and chemical preparations.

### SUMMARY OF THE INVENTION

In accordance with the present invention a novel and useful stirring apparatus for agitating fluids in a container is herein provided.

The stirring apparatus of the present invention utilizes a motor including a rotating output shaft. Motor is operated by a source of power, preferably in the form of battery pack that removeably connects to the motor to activate the same. The motor may be mounted on a housing that supports the motor and source of power. In addition, a clamp may be slidably supported on the housing for adjusting the distance between the clamp and motor. The clamp would be employed to hold the apparatus of the present invention to the container holding the fluid being agitated.

A bar is also employed in the present invention and is removably connected to the rotating output shaft of the motor. A first arm is linked to the bar for rotation. First arm includes a first section and a second section. The first and second sections of the first arm are moveable relative to one another to allow extension and retraction of the first arm relative to the bar. In certain embodiments, the first and second sections may be slidable relative to one another, such that the second section of the first arm is supported in such slidable relationship by the first section of the first arm. The first arm may also include a flange, vane, or fin that extends outwardly from the second section of the first arm.

A second arm is also provided in the apparatus of the present invention and is linked to the first bar for rotation in the same manner as the first arm. The second arm also includes first and second sections that may be slidably connected to one another such that the first section of the second arm supports the second section of the second arm. The second arm may also be provided with a flange that extends outwardly from the second arm.

A stop is also provided in conjunction with the second arm to prevent the second arm from rotating downwardly relative to the bar to form an orthogonal angle with the bar. In other words, the axes of the bar and the second arm would form an acute angle relative to one another. The stop may be provided by the formation of a plate fixed to the bar that engages a notch in the first section of the second arm.

In addition, the apparatus may include a housing which is connected to the motor and a clamp that is moveably supported by the housing. In this manner, the apparatus would be supported by a container for the fluid being stirred and allow for the bar associated with the motor to be positioned as desired relative to the open mouth of the container. The clamp may take the form of a pair of jaws, one of which is spring loaded, that are manually operable through a lever.

It may be apparent that a novel and useful stirring apparatus for agitating a fluid in a container has been hereinabove described.

It is therefore an object of the present invention to provide a stirring apparatus for agitating a fluid in a container that mounts to the container and is adjustable to provide even thorough stirring of the contents of the container.

Another object of the present invention is to provide a stirring apparatus for agitating a fluid in a container utilizing first and second arms that are connected to a bar and a stop mechanism that permits the separation of the first and second arms from one another into zones vertically separated in the fluid found in the container.

Another object of the present invention is to provide a stirring apparatus for agitating a fluid in a container that prevents uneven mixing of the fluid in the container and scorching of the fluid contents of the container where the application of heat to the container is involved.

Another object of the present invention is to provide a stirring apparatus for agitating a fluid in a container that is relatively simple to use and very efficient in mixing the contents of the container, where the mixing arms within the container lie at various depths within the container.

Another object of the present invention is to provide a stirring apparatus for agitating a fluid in a container that is adaptable to containers having various widths and depths.

Yet another object of the present invention is to provide a stirring apparatus for agitating a fluid in a container that includes an adjustment mechanism that operates horizontally and vertically relative to the orientation of the container.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is a top right perspective view of the apparatus of the present invention in place within a container.

FIG. 2 is a front elevational view of the stirring terminus associated with the apparatus of the present invention.

FIG. 3 is a side elevational view of the stirring terminus associated with the apparatus of the present invention.

FIG. 4 is an enlarged front elevational view of the stop mechanism for the second arm of the stirring terminus associated with the apparatus of the present invention.

FIG. 5 is a side elevational view of the apparatus of the present invention mounted to a container where a container is shown in section.

FIG. 6 is a side elevational view of a portion of the apparatus of the present invention during the adjustable position of the clamp.

FIG. 7 is yet another side elevational view of the apparatus of the present invention showing the adjustable clamp in another position from that shown in FIG. 6.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

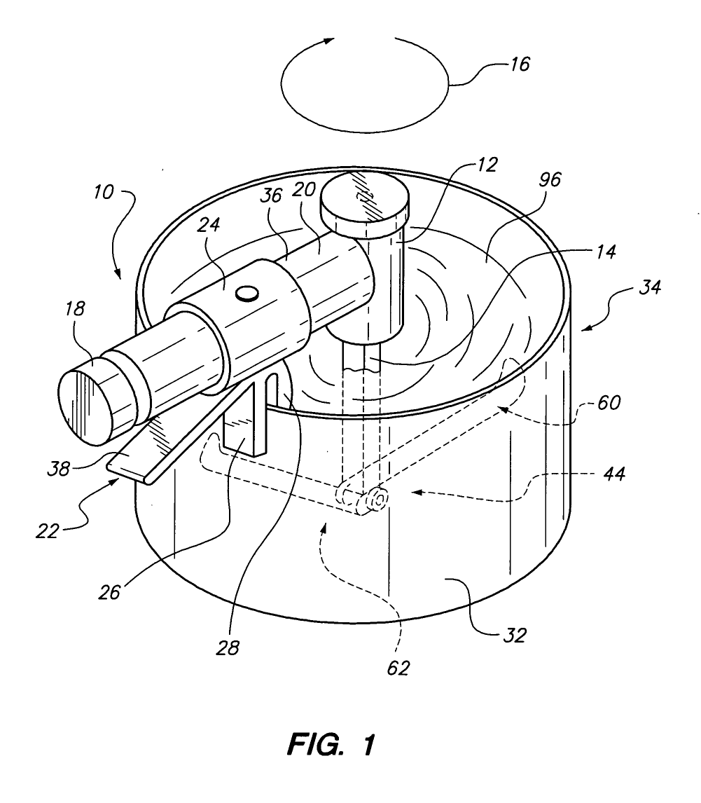

An embodiment of the invention as a whole is depicted in the drawing by reference character 10. The stirring apparatus 10 includes, as one of its elements, a motor 12 which may be a DC Motor of conventional configuration. Motor 12 may take the form of a 12-volt DC Motor having a torque of 2 Kg-cm and a rotational capacity of approximately fifty revolutions per minute. Motor 12 rotates an output shaft 14 according to directional arrow 16, FIGS. 1 and 5-7. Motor 12 is electrically connected to a source of power 18 which may take the form of a battery such as a rechargeable 8.4 volt NiMh unit. Battery 18 may be removable from a housing 20 which connects to motor 12.

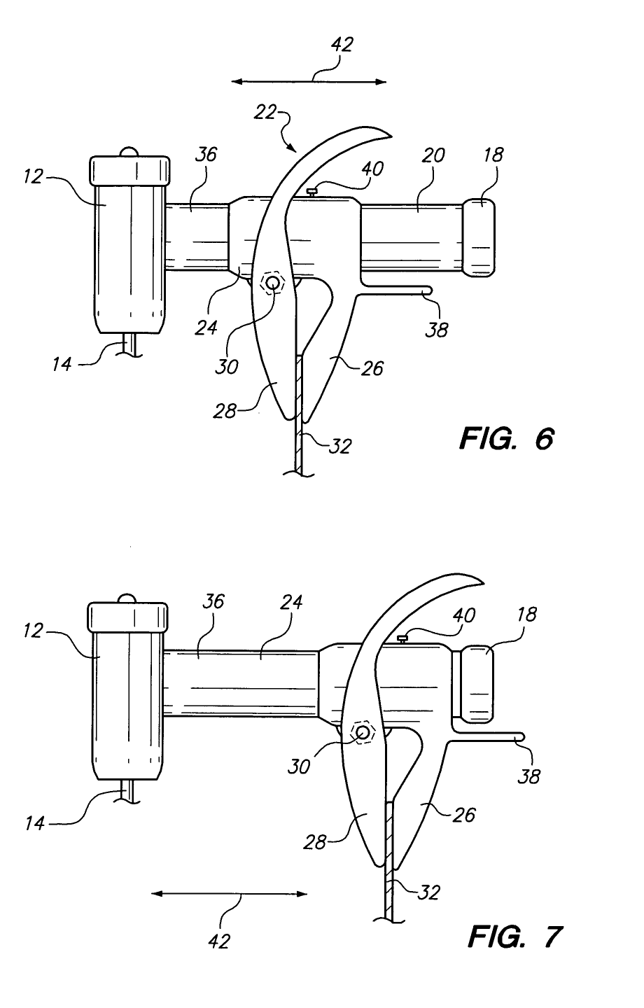

A clamp 22 is formed by a hollow cylindrical base 24 that forms a jaw 26 which interacts with a jaw 28, the latter pivoting about a spring loaded pin 30. Spring loaded pin 30 biases jaw 28 to the side portion 32 of a container 34, best shown in FIGS. 6 and 7. Cylindrical base portion 24 of clamp 22 is capable of sliding along the exterior surface 36 of housing 20, thus, being able to position the rotating shaft 14 within container 34 as desired. Grip or lever 38 permits the user to remove stirring apparatus 10 from container 34 and to reposition the same on container 34 as desired. Set screw 40 holds clamp 22 and, thus, motor 12 in position along outer surface 36 of housing 20. Directional arrow 42 depicts the movement of clamp 22 relative to housing 20, FIGS. 6 and 7.

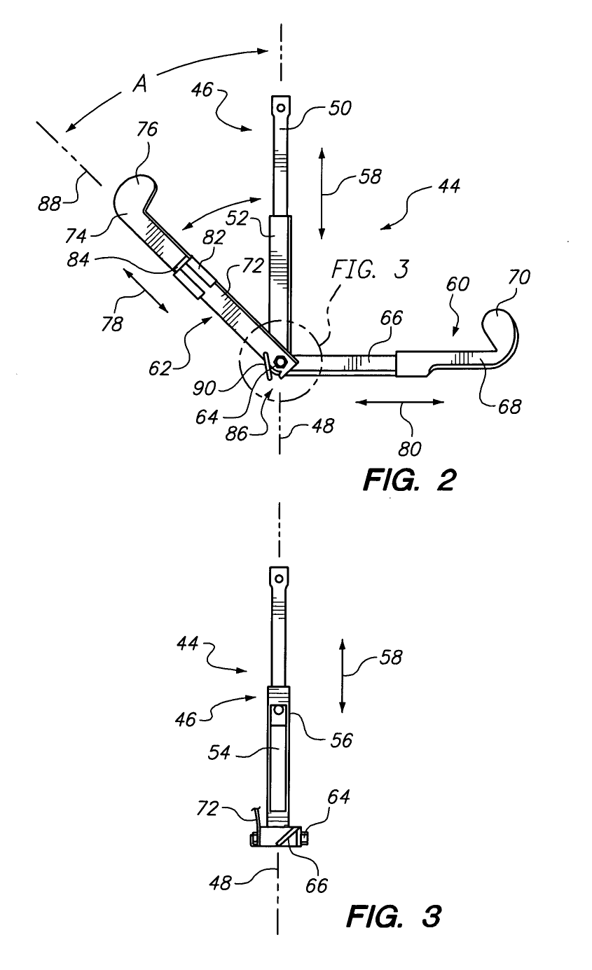

Turning now to FIGS. 2 and 3, it may be observed that a stirring terminus 44 is shown. Stirring terminus 44 includes a bar 46 which generally lies along axis 48, FIGS. 2 and 3. Bar 46 is formed with a first portion 50 and a second portion 52. First portion 50 and second portion 52 of bar 46 positioned in a telescopic relationship. That is to say, first portion 50 of bar 46 is moveable within a cavity 54 of second portion 52 and a protuberance 56 holds first portion 50 of bar 46 within cavity 54. Directional arrow 58 indicates the relative movement between first portion 50 and second portion 52 of bar 46.

Referring again, to FIGS. 2 and 3, it may be apparent that stirring terminus 44 includes a first arm 60 and a second arm 62. First and second arms 60 and 62 are rotatably linked to second portion 52 of bar 46 via pivot pin 64. That is to say, arms 60 and 62 may rotate towards or away from bar 46, the importance of which will be discussed as the specification continues.

First arm 60 is provided with a first section 66 and a second section 68. First and second sections 66 and 68 are moveable relative to one another, specifically in a slidable relationship. A flange or fin 70 is located a tip of second section 68 of first arm 60 and hydrodynamically serves to propel second section 68 outwards from first section as when shaft 14 rotates.

Second arm 62 also includes a first section 72 that is slidably connected to second section 74. Fin 76 lies at the end or tip of second section 74 of second arm 62. As may be seen on FIG. 2, a channel 82 of second section 74 of second arm 62 slidably engages tongue 84 of first section 72 of second arm 62. A similar mechanism allows the hydrodynamic sliding relationship between first section 66 and second section 68 of first arm 60, depicted by directional arrow 80. In this manner, first and second arms 60 and 62 conform to containers of varying widths or diameters. It should be realized at first portion 50 of bar 46 include the necessary fitting to be held outwardly from shaft 14 of motor 12, and may be of a conventional configuration, in this regard.

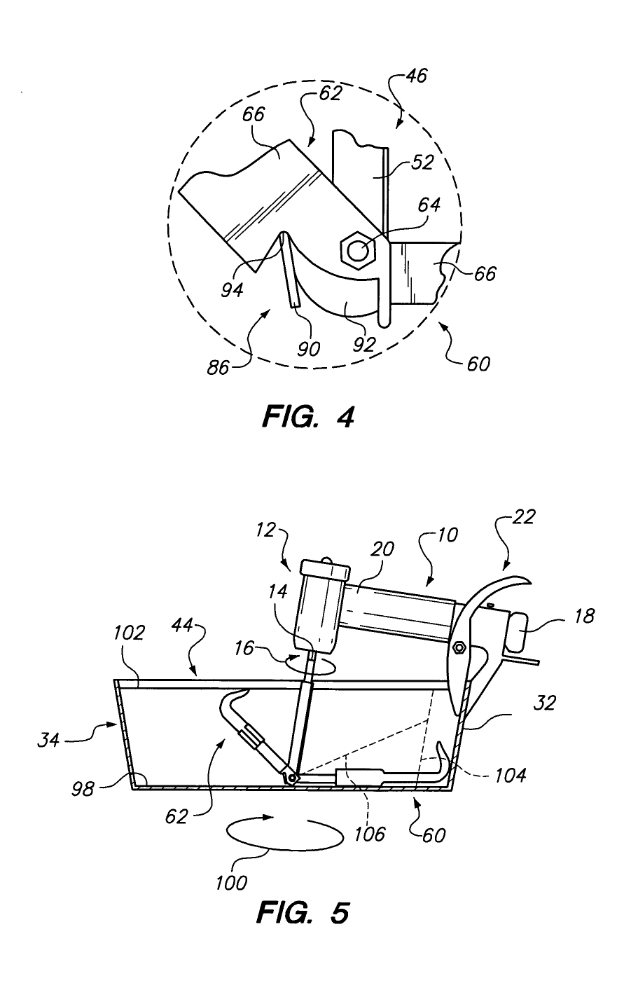

With reference to FIG. 4, a stop 86 is shown to limit the rotational travel of second arm 62 relative to bar 46. Again, referring to FIG. 2, it may be seen that an angle A is formed by stop 86. That is to say, arm 62 may extend outwardly from bar 46 at angle A or at any lesser angle, relative to axes 48 and 88 of bar 46 and second arm 62, respectively. Bar 86 may take the form of a plate fixed to the end 92 of second portion 52 of bar 46. A notch 94 in first section of first arm 62 engages plate 90 to hold second arm 60 in the position depicted in FIGS. 2 and 5.

In operation, the user places stirring apparatus 10 on side 32 of container 34 shown in FIG. 5. Clamp 22 clips to side 32 of container 34 to allow motor 12 to be positioned above container 34 relative to fluid contents 96 found within container, as shown in FIG. 5. At this point, arm 60 lies against the bottom and the side 32 of container 34 while second arm 62 extends outwardly from bar 36 at angle A shown in FIG. 2. Motor 12 turns according to directional arrow 16 while stirring terminus 44 moves in the same manner, according to directional arrow 100. It should be noted that second arm 62 of stirring terminus 44 moves upwardly or downwardly to the surface 102 of fluid contents 96, and no further. It is believed this action is due to the lifting action of flange or fin 76 passing through fluid contents 96. First arm 60 will remain at the bottom of 98 of container 34 due to the weight of first arm 60 and the pitch of first and second sections 66 and 68, FIG. 3. It should be noted that first arm 60 will form an obtuse angle width axis 48 of stirring terminus 44, when axis 48 is not normal to bottom 98 of container 34, FIG. 5. Thus, the fluid contents 96 are agitated throughout its depth between surface 102 and bottom 98 of container 34 during the stirring motion effected by stirring apparatus 10. Should surface 102 of fluid contents 96 move toward bottom 98 of container 34 through attrition or otherwise, second arm 62 will move downwardly relative to side 32 of container 34, through the slidable interaction between first section 72 and second section of second arm 62. Also, should container 32 include a theoretical side portion 104, FIG. 5, first arm 60 will tend to slide up the side of 104 according to dashed line 106. In this manner, stirring apparatus 10 adjusts to particular depths and widths of containers and to the levels of the fluid contents 96 within such containers. The biasing of arms 60 and 62 through the mechanism hereinabove described will ensure a proper stirring of the fluid contents 96 during the stirring processes, the movement of which is indicated by directional arrow 100.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A stirring apparatus for agitating a fluid in a container comprising:
a. a motor including a rotating output shaft;
b. a source of power said source of power being connected to said motor to activate said rotating output shaft;
c. a bar said bar connecting to said rotating output shaft of said motor;
d. a first arm, said first arm being linked to said bar for rotation with said bar, said first arm including a first section and second section, said first and second sections of said first arm being moveable relative to one another, said first section of said first arm being connected to said bar, said second section of said first arm being supported by said first section of said first arm;
e. a first flange, said first flange extending outwardly from said second section of said first arm;
f. a second arm, said second arm being linked to said bar for rotation with said bar, said second arm including a first section and a second section, said first and second sections of said second arm being moveable relative to each other, said first section bar for rotation relative to said bar, said second section of said second arm being supported by said first section of said second arm;
g. a second flange, said second flange extending outwardly from said second section of said second arm;
h. a stop, said stop limiting said rotation of said first section of said second arm away from said bar to position where said first section of said second arm lies at less than an orthogonal angle relative to said bar.

2. The apparatus of claim 1 in which said first section of said first arm is rotatably connected to said bar.

3. The apparatus of claim 1 in which said bar comprises a first portion and a second portion, said first portion of said bar connecting to said rotating output shaft of said motor, said second portion of said bar being linked to said first and second arms, said second portion of said bar being telescopically held by said first portion of said bar.

4. The apparatus of claim 3 in which said first section of said first arm is rotatably connected to said bar.

5. The apparatus of claim 1 in which said stop comprises a plate fixed to said bar and a notch in said first section of said second arm, said plate engaging said notch in said first section of said second arm.

6. The apparatus of claim 1 which additionally comprises housing, said housing being connected to said motor, and a clamp, said clamp being moveably supported by said housing for adjusting the distance between said clamp and said motor.

7. The apparatus of claim 6 in which said first section of said first arm is rotatably connected to said bar.

8. The apparatus of claim 6 in which said bar comprises a first portion and a second portion, said first portion of said bar connecting to said rotating output shaft of said motor, said second portion of said bar being linked to said first and second arms, said second portion of said bar being telescopically held by said first portion of said bar.

9. The apparatus of claim 8 in which said first section of said first arm is rotatably connected to said bar.

10. The apparatus of claim 6 in which said stop comprises a plate fixed to said bar and a notch in said first section of said second arm, said plate engaging said notch in said first section of said second arm.

11. The apparatus of claim 10 in which said first section of said first arm is rotatably connected to said bar.
